(19) United States
(12) Patent Application Publication
(10) Pub. No.: US 2015/0074184 A1
(43) Pub. Date: Mar. 12, 2015

(54) SYSTEM, APPARATUS AND METHOD FOR MULTIPLE SERVICE DELIVERY

(71) Applicant: Tencent Technology (Shenzhen) Co., Ltd., Shenzhen (CN)

(72) Inventors: Yuejun LIU, Shenzhen (CN); Kai Liu, Shenzhen (CN); Liangliang Fan, Shenzhen (CN); Yi Shan, Shenzhen (CN)

(73) Assignee: Tencent Technology (Shenzhen) Co., Ltd.

(21) Appl. No.: 14/495,577

(22) Filed: Sep. 24, 2014

Related U.S. Application Data
(63) Continuation of application No. PCT/CN2014/079592, filed on Jun. 10, 2014.

(30) Foreign Application Priority Data
Sep. 11, 2013 (CN) 201310412380.5

(51) Int. Cl. H04L 29/08; H04L 29/06

(52) U.S. Cl. CPC H04L 67/16; H04L 67/42; H04L 67/10
USPC 709/203

(57) ABSTRACT

The present disclosure discloses a terminal device, a core component, a server, a system and a service delivery method for delivering multi-service. The terminal device comprises a core component, at least one peripheral component, and at least one interface between the core component and the at least one peripheral component, wherein the at least one peripheral component is configured to provide at least one service and the core component comprises at least one interface configured to be connected to at least one peripheral component, a processor and a non-transitory storage medium.

### CROSS-REFERENCE TO RELATED APPLICATIONS

The present application is a continuation of PCT/CN2014/079592, filed on Jun. 10, 2014 and entitled “SYSTEM, APPARATUS AND METHOD FOR MULTIPLE SERVICE DELIVERY,” which claims priority to a Chinese Patent Application No. 201310412380.5, filed on Sep. 11, 2013, both of which are incorporated by reference in entirety.

### FIELD OF THE TECHNOLOGY

This disclosure relates to a multi-service providing system, a terminal device and a multi-service providing method, and more particularly to a core component, a terminal device, a server, a system and a service delivery method for systematically providing and managing multiple services.

### BACKGROUND

More and more terminal devices for offering various services are integrated into the daily life of people, such as vending machines, ticket vending machines, DVD dispensing machines, public cell phone charging stations and the like.

Oftentimes, terminal devices for different services have different hardware, such as motherboard, peripheral components. For example, an automatic beverage vending machine is generally achieved with an embedded device with an inbuilt specialized operating system and corresponding application programs. The embedded device of a beverage-vending machine normally comprises a processor with a memory or a non-transitory storage medium, a touch screen, a coin/paper money collector, a mechanical component for controlling a beverage to move and a power supply which are respectively connected with the processor. A user may select a beverage by the touch screen after throwing the coins or the paper money into the coin/paper money collector of the beverage-vending machine. Then the processor may output the control instruction for controlling the mechanical component to supply the selected beverage upon receiving the corresponding triggering signal. The motherboard for a terminal device is usually specially designed for the service it provides. Although there are some advantages of function specific motherboard, one disadvantage is that the cost of manufacturing and/or design a terminal device to provide a new service oftentimes is high.

Another problem associated with current terminal devices is that they are usually located with different places and no information exchange between these terminal devices. Thus only those users who are very familiar with the neighborhood or who are just passing by these places may use these terminal devices, i.e. users basically use these terminal devices passively, which results a low utilization rate of the terminal devices or the resource provided. Thus, there remains a need for a systematic management of terminal devices providing different services so that it will increase the utilization rate of the terminal devices and also better serve users.

### SUMMARY OF THE DISCLOSURE

To increase the usage of terminal devices for various services, the present disclosure provides a terminal device, a server, a user terminal and a service delivery method for systematic managing and providing multiple services through terminal devices.

One embodiment of the present disclosure includes a terminal device. The device includes a core component, at least one peripheral component, and at least one interface between the core component and the at least one peripheral component, wherein the service module is configured to provide at least one service. The core component includes at least one interface configured to be connected to the at least one peripheral component, a processor and a non-transitory storage medium, the non-transitory storage medium is configured to store modules comprising: an information collection module configured to collect information with respect to at least one service provided by the device; an information reporting module configured to report the information to a server wherein the server collects information from multiple devices which provide the service; an instruction receiving module configured to receive a service instruction from the server, wherein the server assigns the device to deliver the service based on the information received from multiple devices; and a service delivery module configured to control the at least one peripheral component on the device according to the service instruction to deliver the service.

One embodiment of the present disclosure includes a server. The server includes a processor and a non-transitory storage medium, the non-transitory storage medium is configured to store modules which comprises a service collecting module configured to receive information with respect to at least one service delivered by at least one terminal device; a service management module configured to manage delivery of the at least one service delivered by the least one terminal device according to the information; a user service module configured to receive a service request from a user terminal; a service planning module configured to assign one of the at least one terminal device to deliver the at least one service according to the service request and the information; a service delivery module configured to transmit the service instruction to the assigned terminal device so that the assigned terminal device delivers the service according to the service instruction; and an information feedback module configured to feedback service information of the assigned terminal device to the user terminal.

One embodiment of the present disclosure includes a user terminal. The user terminal comprises a processor and a non-transitory storage medium. The non-transitory storage medium is configured to store a request sending module configured to send a service request of at least one service to a server, wherein the server manages one or more services delivered by one or more terminal devices, and a feedback receiving module configured to receive service information with respect to the one or more services from the server, wherein the server assigns one of the one or more terminal devices to deliver the at least one service.

Another embodiment of the present disclosure provides a service delivery method. The service delivery method comprises collecting, by at least one terminal device, information with respect to at least one service provided by the at least one terminal device; reporting, by the at least one terminal device, the information to a server that receives information from multiple terminal devices; receiving, by one of the at least one terminal device, a service instruction from the server, wherein the server selects the one of at least one terminal device to deliver the service based on the received information; and delivering, by the at least one terminal device, the service based on the service instruction.

Another embodiment of the present disclosure provides another service delivery method. The service delivery method comprises receiving, by a server comprising a processor and a non-transitory storage medium, information with respect to one or more services delivered by a plurality of terminal devices; receiving at least one service request from at least one user terminal; processing the information and the at least one service request; assigning one of the plurality of the terminal devices to deliver a service based on the service request; transmitting a service instruction to the assigned terminal device so that the assigned terminal device delivers the service to the user terminal according to the service instruction; and feedbacking service information of the assigned terminal device with respect to the service request to the user terminal.

In the present disclosure, different terminal devices are simultaneously connected with a server which collects information with respect to different services. The server receives service request from a user terminal and/or from a terminal device, and coordinates the providing of different services based on the service request. The present disclosure can increase the usage of the terminal devices. A user may conveniently obtain various life services through the server and different terminal devices connected with the server to improve the usage of the terminal devices.

### BRIEF DESCRIPTION OF THE DRAWINGS

The accompanying drawings are included to provide a further understanding of the claims, are incorporated in, and constitute a part of this specification. The detailed description and illustrated embodiments described serve to explain the principles defined by the claims. Apparently, the drawings described below only are certain embodiments of the present disclosure, the skilled in the art can obtain other drawings based on these drawings without creative work.

FIG. 1 is a structural block diagram of a service system provided in one embodiment according to the disclosure;

FIG. 2 is a structural block diagram of a core component provided in one embodiment according to the disclosure;

FIG. 3 is a structural block diagram of a core component provided in another embodiment according to the disclosure;

FIG. 4 is a structural block diagram of a terminal device provided in one embodiment according to the disclosure;

FIG. 5 is a structural representation of the terminal device under the first connection mode the embodiment shown in FIG. 4;

FIG. 6 is a structural representation of the terminal device under the second connection mode the embodiment shown in FIG. 4;

FIG. 7 is a structural block diagram of the server provided in one embodiment according to the disclosure;

FIG. 8 is a structural block diagram of the server provided in another embodiment according to the disclosure;

FIG. 9 is a structural block diagram of the user terminal provided in one embodiment according to the disclosure;

FIG. 10 is a flow chart of the service delivery method provided in one embodiment according to the disclosure; and

FIG. 11 is a flow chart of the service delivery method provided in another embodiment according to the disclosure.

### DETAILED DESCRIPTION OF THE EMBODIMENTS

The various embodiments of the present disclosure are further described in details in combination with accompanying drawings and embodiments below. Like numbered elements in the same or different drawings perform equivalent functions. It should be understood that the specific embodiments described here are used only to explain the present disclosure, and are not intended to limit the present disclosure.

When describing a particular example, the example may include a particular feature, structure, or characteristic, but every example may not necessarily include the particular feature, structure or characteristic. This should not be taken as a suggestion or implication that the features, structure or characteristics of two or more examples, or aspects of the examples, should not or could not be combined, except when such a combination is explicitly excluded.

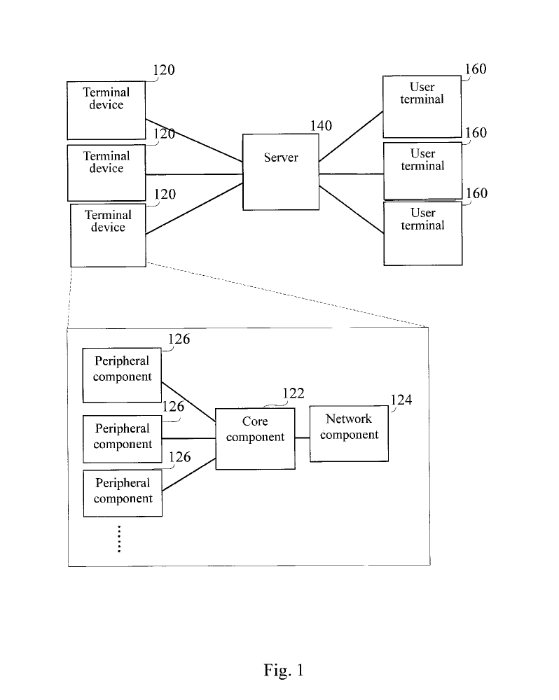

As shown in FIG. 1, the figure is a structural block diagram of a service system according to one embodiment of the present disclosure. The service system comprises at least one terminal device 120, a server 140 connected with at least one terminal device 120, and at least one user terminal 160 which is also connected to the server 140.

The terminal device 120 comprises a core component 122, and a network component 124 integrated or connected to the core component 122 (FIG. 1 only shows connection between the network component 124 and the core component 122 as an embodiment, but it should be understood that the network component may also be integrated into the core component 122), and at least one peripheral component 126 connected to the core component 122. Each terminal device 120 delivers same or different at least one service. The services may include, but not limited to, one of material object sale (such as beverages, snacks, or fruits), ticket sale, self-help charging, expressage service, and taxi service. In other words, the terminal device 120 may be a vending machine, a ticket sale machine, a DVD dispensing machine, a self-help charger, a courier handheld device, a taxi on-board device, and the like.

The terminal device 120 may be connected with the server 140 by a wired network or a wireless network.

The server 140 can be a standalone service or a server cluster consisting of several servers, or a cloud computing center. A server, as used herein, may refer to one or more server computers configured to provide certain server functionalities, such as database management and search engines. A server may also include one or more processors to execute computer programs in parallel.

The server 140 can be accessed to the at least one user terminal 160 by the wired network or the wireless network.

The user terminal 160 may be any appropriate user terminal with certain computing capabilities, such as a smart phone or mobile phone, a panel personal computer, an e-book reader, a notebook computer, a desktop computer or any other user-side computing device. In some embodiments, the user terminal 160 may access the server 140 by a unified access interface. The unified access interface may be an application program operating on the user terminal 160 and communicating with the server 140, such as a smart phone App. In some embodiments, the unified access interface can be a website provided by the server 140 and accessed by user terminal 160 through a browser.

The following provides detailed description on the core component, the terminal device, the server and the user terminal according to different embodiments of the present disclosure.

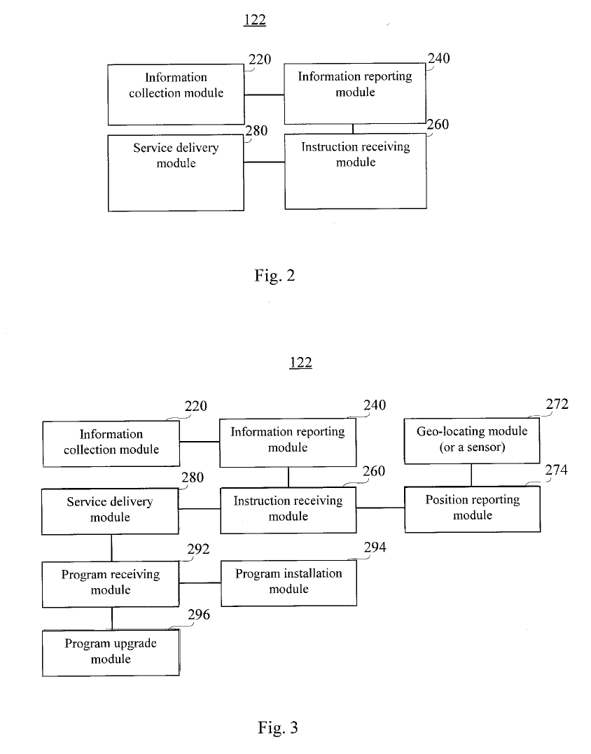

FIG. 2 is a structural block diagram of the core component provided in one embodiment according to the present disclosure. The core component 122 is generally set in the terminal device 120 as a control core. But the core component 122 can also be positioned outside the terminal device if needed. The core component 122 comprises an information collection module 220, an information reporting module 240, an instruction receiving module 260 and a service delivery module 280.

The information collection module 220 is configured to collect information with respect to at least one service provided by the terminal device 120.

The information reporting module 240 is configured to report the information to the server 140 wherein the server 140 collects information from multiple terminal devices 120 which provide the service by the information collection module 220.

The instruction receiving module 260 is configured to receive a service instruction from the server 140, wherein the server 140 assigns a terminal device 120 to deliver the service based on the information received from multiple terminal devices 120.

The service delivery module 280 is configured to control at least one peripheral component 126 on the terminal device 120 according to the service instruction received by the instruction receiving module 260 to deliver the service.

With the core component provided in this embodiment, the terminal device 120 sends the server 140 information with respect to various services provided by the terminal device. The server 140 collects the information and receives service request from a user terminal. The server 140 then coordinates and/or manages various services provided by the terminal device. Thus, the present disclosure can increase the usage of the terminal devices and avoid wasting resource. Also, a user may conveniently obtain various life services through the server and different terminal devices connected to the server to improve the usage of the terminal devices.

FIG. 3 is a structural block diagram of the core component according to another embodiment of the present disclosure. The core component 122 is generally set in the terminal device 120 as a control core. The core component 122 may be an integrated circuit module comprising a processor and a memory or a non-transitory storage medium. In some embodiments, the core component 122 may be a core-board specifically, e.g. ARM (Advanced RISC Machines) core-board. In some embodiments, the core component 122 may be equipped with a custom-made specialized operating system, installed with different application programs according to the life service delivered by the terminal device 120, and the core component 122 can be a minimum system plate that is able to operate independently.

To add different peripheral component 126 to the terminal device 120 to provide various service, in some embodiments, the core component 122 may include several preset universal interfaces to connect different peripheral components 126 to the terminal device 120. These preset universal interfaces may include, but not limited to, some of the following interfaces, such as at least one of a display module interface, an audio acquisition component interface, an audio playing component interface, an image acquisition component interface, a sensor component interface, a machinery component interface, a locating component interface, an input component interface, and a power supply component interface. In some embodiments, the core component 122 comprises at least one interface configured to be connected to the peripheral module 126, a processor and a non-transitory storage medium, the non-transitory storage medium is configured to store modules comprising an information collection module 220, an information reporting module 240, an instruction receiving module 260 and a service delivery module 280.

The information collection module 220 is configured to collect information with respect to at least one service provided by the terminal device 120.

The information reporting module 240 is configured to report the information to a server 140 wherein the server 140 collects information from multiple devices which provide the service.

The instruction receiving module 260 is configured to receive a service instruction from the server 140, wherein the server 140 assigns a terminal device 140 to deliver the service based on the information received from multiple terminal devices.

The service delivery module 280 is configured to control at least one peripheral component 126 on the terminal device 120 according to the service instruction received by the instruction receiving module 260 to deliver the service.

In some embodiments, the core component 122 further comprises a sensor configured to locate a geographic position of the terminal device 120 and the non-transitory storage medium of the core component 122 is further configured to store a position reporting module 274 configured to report the geographic position of the terminal device 120 to the server 140.

In some embodiments, the core component 122 may further comprise a geo-locating module 272 and a position reporting module 274, wherein the geo-locating module 272 is configured to locate the geographic position of the terminal device 120; and the position reporting module 274 is configured to report the geographic position of the terminal device 120 to the server 140.

In some embodiments, the non-transitory storage medium of the core component 122 may further store a program receiving module 292, a program installation module 294 and a program upgrade module 296.

The program receiving module 292 is configured to receive a program installation instruction or a program upgrade instruction or both from the server 140.

The program installation module 294 is configured to install an application program in the terminal device 120 according to the program installation instruction.

The program upgrade module 296 is configured to upgrade the application program in the terminal device 120 according to the received program upgrade instruction.

Through receiving the geographic position of the terminal device 120 reported by the core component 122, the server 140 can thus manage and coordinate the service requested by the user terminal 160 according to the geographic position of the terminal device 120. In other words, a user may know all the terminal devices which provide various services at or near the user's location by just installing an application or accessing a website of the server, both of which are embodiments of a user terminal 160.

FIG. 4 is a structural block diagram of the terminal device according to one embodiment of the present disclosure. In some embodiments, the terminal device 120 may comprise a core component 122, a network component 124 connected to the core component 122, and at least one peripheral component 126 connected to the core component 122 through an interface.

In some embodiments, the core component 122 may be the core component provided in the embodiment as shown in FIG. 2 or FIG. 3.

In some embodiments, the network component 124 may be configured to transmit information between the terminal device 120 and the server 140. The network component 124 can be a communication component between the terminal device 120 and the server 140. In some embodiments, the network component 124 may be, but not limited to, an Ethernet component, a WIFI (Wireless Fidelity) component, a 2G/3G/4G/5G mobile communication component, an optical fiber communication component or the like. In some embodiments, the network component 124 may be directly integrated onto the core component 122. In some embodiments, the network component 124 may also be connected to the core component 122 through the preset universal interface.

The terminal device 120 comprises at least one peripheral component 126, depending on what service it provides. The at least one peripheral component 120 is configured to deliver at least one life service to the user terminal 160 under the control of the core component 122. In some embodiments, the peripheral component 126 may include one or more of the following: a display module, an audio acquisition component, an audio playing component, an image acquisition component, a sensor component, a machinery component, a locating component, an input component, a power supply component and the like.

The display module may include, but not limited to, a liquid crystal display, an electronic ink display, a cathode ray kinescope, a projection component or the like. The audio acquisition component may include, but not limited to, a microphone or the like. The audio playing component may include, but not limited to, a loudspeaker or the like. The image acquisition component may include, but not limited to, a camera and corresponding camera lens components or the like. The sensor component may include, but not limited to, a gravitational acceleration sensor, an electronic compass sensor, a tri-axial acceleration sensor, a light ray sensor, an infrared sensor, a distance sensor or the like.

The machinery component may include, but not limited to, at least one of the following: a coin collector component, a paper currency collector component, a mechanical structure controlling article rotation, a mechanical structure controlling ingress and egress of the article to and from the terminal device, an IC card reading and writing component, and a ticket printing component, and the locating component includes but not limited to at least one of GPS (Global Positioning System), LBS (Location Based Service), and the like.

The input component may include, but not limited to, a button component, a touch screen component, a bar code identification component, a two-dimension code identification component, a NFC (Near Field Communication) component, a fingerprint identification component, a pupil identification component or the like.

In some embodiments, the core component 122 may be connected to the peripheral component 126 in at least two modes, Mode 1 and Mode 2.

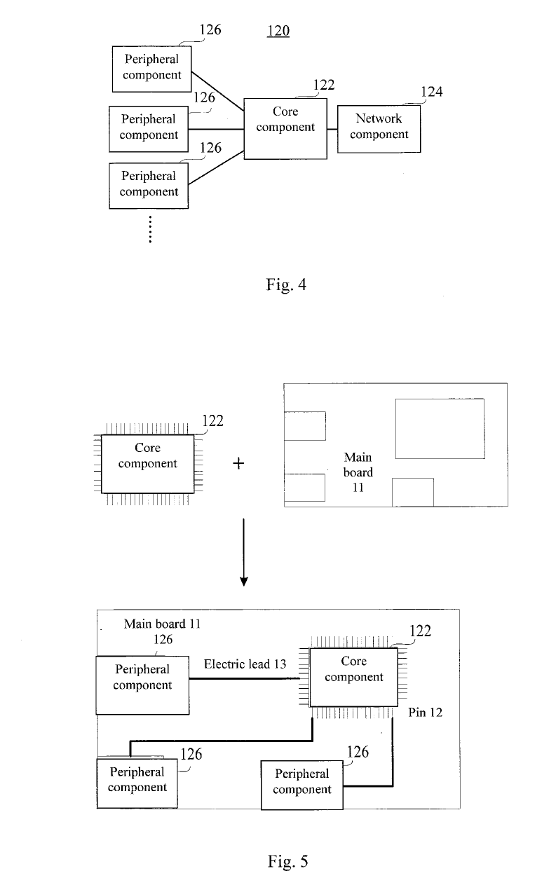

In Mode 1: the core component 122 is set onto a base plate, and connected with at least one peripheral component 126 via the base plate; for example, at least one peripheral component 126 is set onto a main board 11 with a preset universal interface, such as a pin connector, and the core component 122 is connected to the main board 11 via a pin 12 and communicates with each peripheral component 126 via the electric lead 13 on the pin 12 and the main board 11, as shown in FIG. 5.

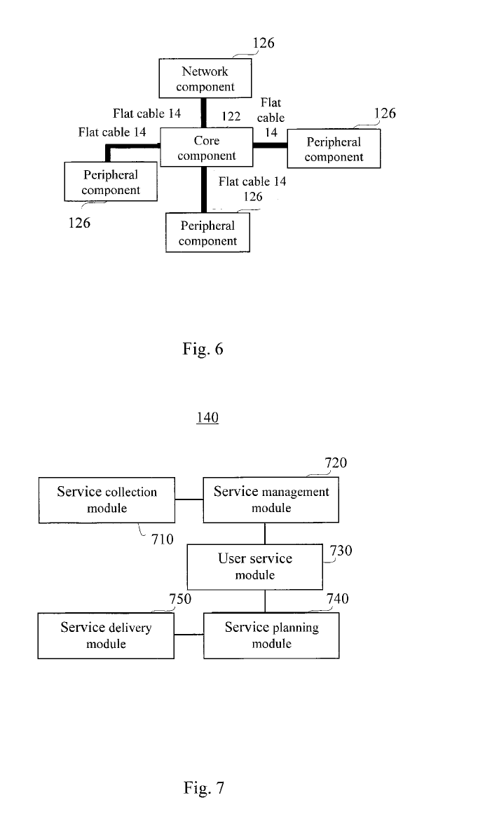

In Mode 2: the core component 122 is directly connected to the at least one peripheral component 126 via same or different connectors. For example, the connector may be a flat cable supporting different preset universal interfaces, and at least one peripheral component 126 is connected to the core board 122 via the flat cable 14 with the preset universal interface, as shown in FIG. 6.

Different terminal devices may deliver same of different life services, and same terminal device may deliver at least one life service. The life services provided by the terminal device 120 include but limited to at least one of material object sale, ticket sale, self-help charging, expressage service, and taxi service. The terminal device 120 may comprise different peripheral components according to the delivered different life services, specifically:

In some embodiments, if the service includes some material object sale, like a beverage vending machine, the terminal device 120 may generally comprise one and more of the following: a display module, a coin collector component, a paper currency collector component, a mechanical structure controlling article rotation, a mechanical structure controlling ingress and egress of the article to and from the terminal device, an IC card reading and writing component, the bottom component, the NFC component, and the like;

In some embodiments, if the life service includes the ticket sale, like a ticket dispensing machine, the terminal device 120 may generally comprise one and more of the following: a ticket printing component, a display module, a coin collector component, a paper currency collector component, an IC card reading and writing component, a bottom component, a NFC component, a fingerprint identification component, a pupil identification component and the like;

In some embodiments, if the service includes the self-help charging, the terminal device 120 generally comprises the display module, the coin collector component, the paper currency collector component, the IC card reading and writing component, the touch screen component, the bottom component, the NFC component and the like; and

In some embodiments, if the service includes the expressage service, the terminal device 120 may generally comprise one and more of the following: the display module, the coin collector component, the paper currency collector component, the mechanical structure controlling article rotation, the mechanical structure controlling ingress and egress of the article to and from the terminal device, the IC card reading and writing component, the touch screen component, the bottom component, the NFC component, and the like.

Things like that are no longer enumerated here. Nonetheless, it is noted that the core component 122 provides the preset universal interfaces, so that when different terminal devices 120 that provide various service are needed, a manufacturer only needs to custom-make the corresponding main board 11, or adding the corresponding peripheral components 126 that are connected to the core component 122 via the interfaces. Corresponding application programs can be installed on the core component and there is no need to redesign the core component 122. By this modularized design, it may be easy to upgrade, expand, modify and maintain the terminal device 120 in the future. For example, the terminal device 120 of a beverage sale machine may be easily modified into a cinema ticket sale machine.

While the terminal device provided this embodiment has the advantages of the embodiment shown in FIG. 2 or FIG. 3, different terminal devices may be made of the core component, the network component, and different peripheral component, and it is very easy to upgrade, expand, modify and maintain the terminal device; the terminal device solve the problem that relative fixed structure and function of the existing device only meet the user demand in single scene or specific scene. The terminal device has such advantages as functional diversification, convenient upgrade and disassembly, recycling and reusing of damaged or discarded component.

FIG. 7 is a structural block diagram of the server according to another embodiment of the present disclosure. In some embodiments, the server 140 may comprise a service collecting module 710, a service management module 720, a user service module 730, a service planning module 740, a service delivery module 750 and an information feedback module 760.

The service collecting module 710 is configured to receive information with respect to at least one service delivered by at least one terminal device.

The service management module 720 is configured to manage delivery of the at least one service delivered by the least one terminal device 120 according to the information collected by the service collecting module 710.

The user service module 730 is configured to receive a service request from a user terminal.

The service planning module 740 is configured to configured to assign one of the at least one terminal device to deliver the at least one service according to the service request received by the user service module 730 and the information collected by the service collecting module 710.

The service delivery module 750 is configured to transmit the service instruction to the assigned terminal device so that the assigned terminal device delivers the service according to the service instruction received by the user service module 730.

The information feedback module 760 is configured to feedback service information of the assigned terminal device to the user terminal.

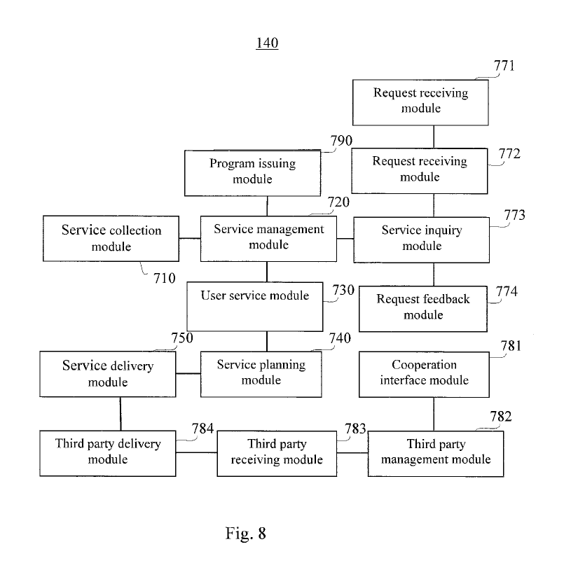

FIG. 8 is a structural block diagram of the server according to another embodiment of the present disclosure. In some embodiments, the server 140 may comprise a service collecting module 710, a service management module 720, a user service module 730, a service planning module 740, a service delivery module 750 and an information feedback module 760.

The service collecting module 710 is configured to receive information with respect to at least one service delivered by at least one terminal device.

The service management module 720 is configured to manage delivery of the at least one service delivered by the least one terminal device 120 according to the information collected by the service collecting module 710.

The user service module 730 is configured to receive a service request from a user terminal.

The service planning module 740 is configured to configured to assign one of the at least one terminal device to deliver the at least one service according to the service request received by the user service module 730 and the information collected by the service collecting module 710.

The service delivery module 750 is configured to transmit the service instruction to the assigned terminal device so that the assigned terminal device delivers the service according to the service instruction received by the user service module 730.

The information feedback module 760 is configured to feedback service information of the assigned terminal device to the user terminal.

In some embodiments, the server 140 may further comprise the following modules:

a position storing module 771 configured to store geographic positions of at least some terminal devices, wherein the geographic position of the terminal device may be the installation position of the terminal device or the geographic position reported by the terminal device. In some embodiments, if the terminal device 120 is not a mobile terminal device, the position storing module 771 pre-stores the installation position of the terminal device 120. In some embodiments, if the terminal device 120 is a mobile device with a locating component, the terminal device 120 may report its geographic position to the server 140 by the network component 126 at preset time interval, and the position storing module 771 may store and upgrade the geographic position of the terminal device 120;

a request receiving module 772, configured to receive an inquiry request from the user terminal, wherein the inquiry request comprises a geographic position of the user terminal;

a service inquiry module 773, configured to search at least some services available for delivery within a desired geographic scope for the service from the user terminal according to the geographic positions of the at least some terminal devices; and

an inquiry feedback module 774, configured to feedback the found services to the user terminal.

In some embodiments, if the service request received by the user service module 730 carries the geographic position of the user terminal, the service planning module 740 is further configured to assign one of the at least one terminal device located within the desired geographic scope to deliver the service by the user service module 730.

In some embodiments, the information feedback module 760 is configured to feedback the service information of the terminal device delivering the service assigned by service planning module 740 to the user terminal, and the service information comprises the geographic position and/or navigation information of the terminal device that will deliver the service.

In some embodiments, the non-transitory storage medium of the server 140 may further comprise a cooperation interface module 781, a third party management module 782, a third party receiving module 783, and a third party delivery module 784.

The cooperation interface module 781 is configured to connect with a third party service system via a third party cooperation interface, and the third party service system is configured to deliver at least one third party service. The third party service may comprise an article service and/or a non-article service, wherein the non-article service may include at least one of an identity authentication service, a payment service, a bus inquiry service, a navigation service, a taxi calling service, restaurant reserving service, self-help recharging service, and the like.

The third party management module 782 is configured to manage the at least one third party service.

The third party receiving module 783 is configured to receive at least another service request from the user terminal for the at least one third party service.

The third party delivery module 784 is configured to cooperate with the third party service system to deliver the at least one third party service to the user terminal.

In some embodiments, the non-transitory storage medium of the server 140 may further comprise a program issuing module 790, wherein the program issuing module 790 is configured to issue a program installation instruction or a program upgrade instruction to each terminal device 120 so that the terminal device receives the program installation instruction or the program upgrade instruction sent by the server to install a local application program according to the program installation instruction or upgrade the local application program according to the program upgrade instruction.

The server provided in these embodiments assigns the terminal device near a user's location based on the geographic position of the terminal devices and the geographic position of the user, so that it can provide services to the user more conveniently and efficiently and also further improve the usage of the terminal devices and reduce resource limit or waste.

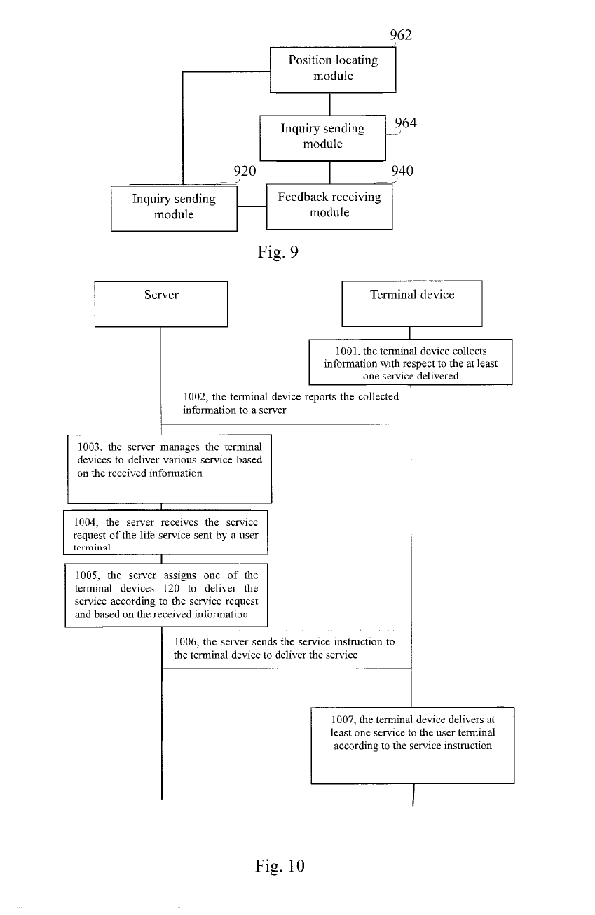

FIG. 9 is a structural block diagram of the user terminal according to one embodiment of the present disclosure. In some embodiments, the user terminal 160 may comprise a request sending module 920 and a feedback receiving module 940.

The request sending module 920 is configured to send a service request of at least one service to the server 140, wherein the server 140 manages one or more services delivered by one or more terminal devices 120.

The feedback receiving module 940 is configured to receive service information with respect to the one or more services from the server 140, wherein the server assigns one of the one or more terminal devices 120 to deliver the at least one service.

In some embodiments, the user terminal 160 may further comprise a position locating module 962 and an inquiry sending module 964.

The position locating module 962 is configured to obtain a desired geographic position for delivering the service. This desired geographic position can be obtained either by input from a user, or alternatively, it can be obtained automatically by the user terminal, for example, when the user terminal is an App on a smart phone.

The inquiry sending module 964 is configured to send an inquiry request to the server 140, wherein the inquiry request comprises the obtained geographic position for delivering the service so that the server searches at least some services available for delivery within a preset scope of the obtained geographic position according to at least some geographic positions of the terminal devices 120 stored in the server 140, and feeds back the found services to the user terminal 160, wherein the feedback receiving module 940 is further configured to receive the found services from the server 140.

Through the service request with a desired geographic position of a user sent to the server, the user terminal provided in this embodiment can enable the server to decide the terminal device delivering the service according to the geographic position of the user or the desired geographic position so that the user more can conveniently obtain various services.

To better illustrate this, for example in some embodiments, several terminal devices 120 in the service system deliver the beverage vending service, and the terminal devices 120 may report local beverage inventory to the server 140 at preset time interval or after one bottle of the beverage is sold so that the service delivered by it is reported to the server 140. The server 140 manages various services able to be concurrently delivered by the service system after collection of the information on the life service reported by the terminal devices, including the beverage vending service.

In the same example, the user terminal 160 used by a user A sends the inquiry request by an application program or a website, and then the server 140 feeds back the services that can be delivered to the user terminal 160 at that time so that user A selects one or more desired services.

After the server 140 receives the service request, such as purchasing a beverage, entered by user A through the application program or the website and sent by the user terminal 160, assuming, for example, that the service request contains such requirements as “1 bottle of Feida beverage, Class III freezing, and shortest walking distance”, the server 140 may decide which of the terminal devices 120 to deliver the service according to the service requested by the service request. The terminal device 120 to deliver the service may be the terminal device 120 which has the shortest walking distance from the user terminal 160 and has a “Feida” beverage to provide the vending service.

After that, the server 140 sends the service instruction to the assigned terminal device 120, and the terminal device 120 may reserve 1 bottle of Feida beverage of Class III freezing; meanwhile, the server 140 feeds back the geographic position and/or navigation service of the assigned terminal device 120 to deliver the service to the user terminal 160. Finally, the user A may find the terminal device 120 according to the geographic position and/or navigation service of the terminal device 120 fed back by the server 140 and obtain the Feida beverage.

In another specific exemplary scene, the several terminal devices 120 in the service system in some embodiments is a cinema ticket vending service, and the terminal devices 120 may report local cinema ticket inventory to the server 140 at preset time interval or after one cinema ticket is sold so that the ticket service delivered by it is reported to the server 140. The server 140 manages various services that can be instantly delivered by the service system after collection of the information on the service reported by the terminal devices, including the cinema ticket vending service.

In the same exemplary scene, the user terminal 160 used by a user B sends the inquiry request to the server 140 through an application program or the website, the inquiry request may include the geographic position of the user B or a desired geographic position for the service input by user B, and then the server feeds back the life services able to be delivered within 1000 m scope of user B or the desired geographic position for the service to the user terminal 160 so that user B selects the desired life service.

In the same exemplary scene, after the user terminal 160 used by user B completes purchase of the cinema ticket on the server 140 through the application program or the website and payment is completed, the server 140 may generate a redemption code and list all terminal devices 120 that is able to deliver the cinema ticket vending service within 1000 m of user B or the desired geographic position for the service entered by user B. User B can choose any of those listed terminal device 120 to deliver the ticket.

After that, the server 140 provides one redemption code to the user terminal 160, and feeds back the geographic position of the terminal device 120 to deliver the cinema ticket vending service within 1000 m scope of user B or the desired geographic position for the service to the user terminal 160; meanwhile, the server 140 sends the service instruction with the redemption code to the listed terminal device(s) 120 to deliver the cinema ticket. Finally, user B may select one of the listed terminal devices 120 to obtain the cinema ticket by the redemption code. The selected terminal device 120 may receive the redemption code by the core component 122, inquire the cinema ticket corresponding to the redemption code by the core component 122, and print and provide the cinema ticket to user B by the ticket printing component.

In another specific exemplary scene, one terminal device 120 in the service system may originally only deliver cinema ticket vending service, but after the server 140 sends a program upgrade instruction to the terminal device 120 to upgrade its program, then the terminal device 120 may also be able to provide railway ticket and bus ticket vending service. Also for example, a terminal device 120 delivering hamburger vending service during period from January to March in the service system may deliver cold drinks service during period from April to June by replacement of the machinery component after reinstallation of the program by the server 140.

FIG. 10 is a flow chart of the service delivery method according to another embodiment of the present disclosure. This embodiment further illustrates the application of the service delivery method in the service system shown in FIG. 1. In the embodiments, the service delivery method may comprise the following steps.

Step 1001, the terminal device 120 collects information with respect to at least one service provided by at least one terminal device 120.

Step 1002, the terminal device 120 reports the collected information to a server 140 wherein the server receives information from multiple terminal devices 120.

Step 1003, the server 140 manages the terminal devices to deliver the service based on the received information.

Step 1004, the server 140 receives the service request of the life service sent by a user terminal 160.

Step 1005, the server 140 assigns one of the terminal devices 120 to deliver the service according to the service request and based on the received information.

Step 1006, the server 140 sends the service instruction to the terminal device to deliver the service;

Correspondingly, the terminal device 120 receives the service instruction sent by the server. Meanwhile, the server 140 feeds back the service information of the terminal device delivering the service to the user terminal.

The service information may include the geographic position and/or navigation information of the terminal device delivering the service.

Correspondingly, the user terminal 160 receives the service information of the terminal device to deliver the service feedback by the server.

Step 1007, the terminal device delivers at least one service to the user terminal according to the service instruction.

It should be noted that not all the forgoing steps are required in each embodiment. For example, the service delivery method for the terminal device 120 may be achieved independently by Step 1001, Step 1002, Step 1006 and Step 1008 of the above method, and corresponds to the embodiments shown in FIG. 2, FIG. 3 and FIG. 4. The service delivery method for the server may also be achieved independently by Step 1003, Step 1004, Step 1005, Step 1006 and Step 1007 of the above method and corresponds to the embodiments shown in FIG. 5. The above embodiments of corresponding devices and methods may be referenced mutually. One of ordinary skill in the art would appreciate that there are numerous apparatuses that could be included with the present disclosure, and the embodiments of the present disclosure may be used in combination.

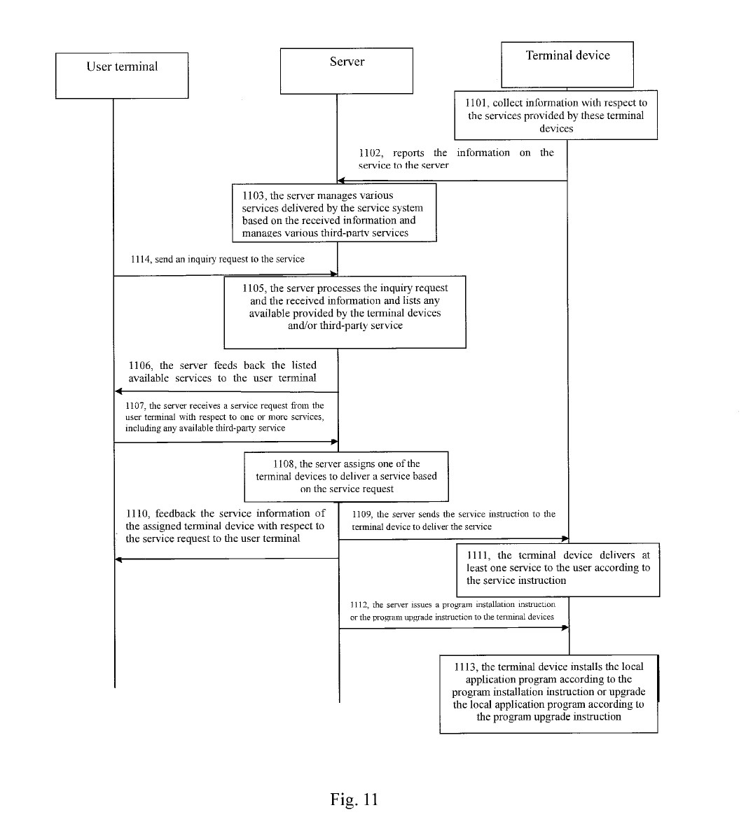

FIG. 11 is a flow chart of the service delivery method according to another embodiment of the present disclosure. For example, assuming that the terminal devices include a beverage vending machine, a taxi on-board device and a courier handheld device, this embodiment illustrates application of the service delivery method in the service system shown in FIG. 1. In this embodiment, the service delivery method may comprise the following steps.

Step 1101, the terminal devices 120 collect information with respect to the services provided by these terminal devices.

Specifically in some embodiments:

if the terminal device is the beverage vending machine, the terminal device collects the local beverage inventory information at preset time interval or after one bottle of the beverage is sold, and uses the beverage inventory information as the information on the service;

if the terminal device is the taxi on-board device, three operating modes may be set on the terminal device: an occupying mode, an idle mode and a service stop mode, and the terminal device collect its geographic position and the operating modes as the information on the life information at preset time interval or in the idle mode; and

if the terminal device is the courier handheld device, the terminal device may use the courier number scanned by a camera or bar code identification component, current position, available door-to-door collection and delivery and the like as the information on the life information.

Step 1102, the terminal device reports the information on the service to the server 140, wherein the terminal device may comprises same or different network component that receives information from multiple terminal devices, and the terminal device may report the collected information with respect to the services to the server by its network component. Specifically in some embodiments:

if the terminal device is the beverage vending machine, the network component comprised in the beverage vending machine may be an Ethernet component, and the terminal device may report the beverage inventory information to the server by Ethernet;

if the terminal device is the taxi on-board device, the network component comprised in the taxi on-board device may be a 3G mobile communication component, and the terminal device report its geographic position and operating modes to the server by the 3G mobile network; and

if the terminal device is the courier handheld device, the network component comprised in the courier handheld device may be a WIFI component, and the terminal device may reports the courier number, the current position and the available door-to-door collection and delivery to the server by the WIFE wireless network.

Correspondingly, the server 140 receives the information with respect to at least one service reported by the terminal devices 120.

Step 1103, the server manages various services delivered by the service system according to the received information with respect to at least one service and manages various third party services to be provided by the service system;

After receiving information with respect to at least one life service reported by the terminal devices, the server manages various services that can be delivered by the service system at that time according to the received information with respect to at least one service.

At the same time, the server may store the geographic positions of all or partial terminal devices. The geographic position may be the installation position of the terminal device, or the geographic position reported by the terminal device. In some embodiments, the service system may also be connected with at least one third-party service system by a third part cooperation interface, wherein the at least one third-party service system is configured to deliver at least one third party service, and the third party services include the article service and the non-article service. The server may thus simultaneously manage various third party services that can be delivered by the service system.

Step 1104, the user terminal 160 sends an inquiry request to the server.

In some embodiments, the user terminal may send the inquiry request to the server by a pre-installation application program or through access to the preset website. In some embodiments, the user terminal 160 may send the inquiry request with the geographic position of the user terminal or a desired geographic position for delivering the service to the server by the unified access interface. In some embodiments, the user terminal may firstly locate the geographic position of the user terminal, and then send the inquiry request to the server by the application program or the preset website. Or in other embodiments, the user terminal may obtain the preset and stored geographic position (this position must not be the actual position of the user terminal) as the geographic position of the user terminal, and then send the inquiry request to the server via the application program or the preset website.

Correspondingly, the server 140 receives the inquiry request sent by the user terminal 160 and the inquiry request carries the geographic position of the user terminal or a desired geographic position for delivering the service input by a user.

Step 1105, the server processes the inquiry request and the received information and lists any available provided by the terminal devices and/or third-party services that can be delivered within the preset scope indicated by the geographic position of the user terminal according to the geographic positions of the terminal device or the desired geographic position for delivering the service.

In some embodiments, if the inquiry request carries the geographic position of the user terminal or the desired geographic position for delivering the service, the server lists the life service that can be delivered within the preset scope indicated by the geographic position of the user terminal according to the geographic positions of the terminal device. For example, the server inquires 1 beverage vending machine delivering the beverage vending service, 1 taxi delivering taxi service, and 1 courier delivering express delivery and collection services within 100 m scope of the geographic position of the user terminal. In some embodiments, the service system may assign one of the terminal devices to deliver a service based on the service request.

At the same time, the server may inquire the third party service that can be delivered within the preset scope indicated by the geographic position of the user terminal according to the geographic positions of the terminal device; however, as non-article services are not subject to geographic restrictions, the third party services may not be limited by the geographic position of the user terminal Instead, in some embodiments, the server can provide the desired geographic position for delivering the non-article service to the third-party service so that they can provide the service accordingly.

Step 1106, the server feeds back the listed available services, including any third party services, to the user terminal.

The server may feedback the listed available services and/or third party services to the user terminal by an application program or a website, for example the server feeds back relevant beverage vending, taxi information and expressage information to the user terminal, and the user may view the vending beverage, the position of the taxi and the expressage, and the like.

Correspondingly, the user terminal receives the listed available services and/or third party services fed back by the server.

Step 1107, the server receives a service request from the user terminal with respect to one or more services, including any available third-party services.

After receiving various listed available services fed back by the server, the user terminal selects one or more desired services; and then the user terminal sends the service request to the server through the application program or the website. In some embodiments, the service request sent by the user terminal may carry the geographic position of the user or a desired geographic position for the services.

Correspondingly, the server receives the service request of the services and/or the third party services. Specifically, in some embodiments, for example:

if the terminal device is a beverage vending machine, the service request received by the server may be beverage reserving request, and the information carried in beverage reserving request may include “the user X, the geographic position of the user, one bottle of soda water and Class III freezing;

if the terminal device is a taxi on-board device, the service request received by the server may be the taxi taking request, and the information carried in the taxi taking request may include “the user X, the telephone number and position of the and destination and the like”; and

if the terminal device is a courier handheld device, the service request received by the server may be expressage request, and the information carried in the expressage request may include “the user X, the telephone number and address of the target address, details of posted article, packing requirement and the like”

Step 1108, the server assigns one of the terminal devices to deliver a service based on the service request.

After receiving the service request from the user terminal, the server may assign the terminal device to deliver the service from all terminal devices according to the service request of the user terminal. In some embodiments, the server may assign a terminal device that is able to deliver the services and closest to the geographic position of the user or the desired geographic position according to the geographic positions of the terminal device, and the user or the desired geographic position for the services.

Meanwhile, in some embodiments, the server may provide the information of the assigned terminal device(s) to the user terminal for confirmation, and then it is implemented specifically after confirmation of the user terminal.

Step 1109, the server transmits a service instruction to the assigned terminal device so that the assigned terminal device delivers the service to the user terminal according to the service instruction.

In some embodiments, if the terminal device is the beverage vending machine, the server may send the service instruction to the terminal device, and the information carried in the service instruction includes “the user X, one bottle of soda water and Class III freezing.

In some embodiments, if the terminal device is the taxi on-board device, the server may send the service instruction to the terminal device, and the information carried in the service instruction may include “the user X, the telephone number and position of the and destination and the like”;

In some embodiments, if the terminal device is the courier handheld device, the server may send the service instruction to the terminal device, and the information carried in the service instruction may include “the user X, the telephone number and address of the target address, details of posted article, packing requirement and the like”

Correspondingly, the terminal device receives the service instruction sent by the server.

Step 1110, the server feedback the service information of the assigned terminal device with respect to the service request to the user terminal.

The service information may include the geographic position and/or the navigation information of the terminal device delivering the service so that the user may rapidly and conveniently find the terminal device(s) according to the navigation information.

Correspondingly, the user terminal receives the service information of the assigned terminal device with respect to the service request feedback by the server.

Step 1111, the terminal device delivers at least one service to the user according to the service instruction.

In some embodiments, if the terminal device is the beverage vending machine, after receiving the service instruction, the terminal device may lock one bottle of the soda water and set its freezing class into III. When the user obtain the reserved soda water, the terminal device complete user identity authentication by the core component, the two-dimension code identification component, the fingerprint identification component, the pupil identification component and other peripheral components; then the terminal device completes the payment by the coin collector component, the paper currency collector component, the IC card reading and writing component, and the NFC component; finally the terminal device delivers the beverage to the user by the mechanical structure controlling article rotation, and the mechanical structure controlling ingress and egress of the article to and from the terminal device.

In some embodiments, if the terminal device is the taxi on-board device, after receiving the service instruction, the terminal device may show the information in the service instruction to a driver, and the driver provides the taxi service to the user according to the information in the service instruction.

In some embodiments, if the terminal device is the courier handheld device, after receiving the service instruction, the terminal device may show the information in the service instruction to the courier, and the courier provides the expressage service according to the information in the service instruction.

In some embodiments, the navigation service, the identity authentication service and/or the payment service may be provided by some third party services, and the server may coordinate and provide the third party services to the user together with the third party service system.

Step 1112, the server issues a program installation instruction or the program upgrade instruction to the terminal devices.

In some embodiments, when it is needed to install or upgrade the whole service system, as different core plates may be used for the terminal devices, the sever may issue same or different program installation instruction or program upgrade instruction to the terminal devices.

Correspondingly, the terminal device receives the program installation instruction or the program upgrade instruction sent by the server.

Step 1113, the terminal device may install the local application program according to the program installation instruction or upgrade the local application program according to the program upgrade instruction sent by the server.

In the service delivery method provided in this embodiment, the terminal device near the user may be selected to deliver the service according to the geographic position of the terminal device and the geographic position of the user or the desired delivery location for the service so that the user may conveniently obtain various life services and thus this method will improve the usage of the terminal device and reduce resource limit or waste.

It should be noted that not all the forgoing steps are required in each embodiment for the service delivery method in the present disclosure. For example, the service delivery method for the terminal device may be achieved independently by Step 1101, Step 1102, Step 1109, Step 1111 and Step 1113 of the above method, and corresponds to the embodiments shown in FIG. 2, FIG. 3 and FIG. 4. The service delivery method for the server may be achieved independently by Step 1103, Step 1104, Step 1105, Step 1106, Step 1107, Step 1108, Step 1109, Step 1110 and Step 1112 of the above method and corresponds to the embodiments shown in FIG. 5. The above embodiments of corresponding devices and methods may be referenced mutually. One of ordinary skill in the art would appreciate that there are numerous apparatuses that could be included with the present disclosure, and the embodiments of the present disclosure may be used in combination.

The aforesaid preferred embodiment modes may be used in combination. In addition, as used in the present application disclosure, the term “module” may refer to include the various software programs object or and/or sets of instructions stored in the memory and to be executed by one or more processors routine executed on the terminal device, the user terminal or the server.

The technicians skilled in the art may understand the achievement of the all or partial steps of the above embodiments are completed by hardware and may be also completed by instructing relevant hardware with the program. The program may be stored in a computer readable storage medium and the storage medium may be a read-only memory, a disk or light disk, and the like.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the disclosure and its practical applications, to thereby enable others skilled in the art to best utilize the disclosure and various embodiments with various modifications as are suited to the particular use contemplated.

Reference throughout this specification to “one embodiment,” “an embodiment,” “example embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an example embodiment,” or the like in the singular or plural in various places throughout this specification are not necessarily all referring to the same embodiment. Furthermore, the particular features, structures, or characteristics may be combined in any suitable manner in one or more embodiments.

1. A device, comprising: a core component, at least one peripheral component, and at least one interface between the core component and at least one peripheral component, wherein the at least one peripheral component is configured to provide at least one service and the core component comprises:
at least one interface configured to be connected to the at least one peripheral component, a processor and a non-transitory storage medium, the non-transitory storage medium is configured to store modules comprising:
an information collection module configured to collect information with respect to at least one service provided by the device;
an information reporting module configured to report the information to a server wherein the server collects information from multiple devices which provide the service;
an instruction receiving module configured to receive a service instruction from the server, wherein the server assigns the device to deliver the service based on the information received from multiple devices; and
a service delivery module configured to control at least one peripheral component on the device according to the service instruction to deliver the service.

2. The device according to claim 1, wherein the core component further comprises a sensor configured to locate a geographic position of the device and the non-transitory storage medium is further configured to store a position reporting module configured to report the geographic position of the device to the server.

3. The device according to claim 1, wherein the non-transitory storage medium is further configured to store modules comprising:
a program receiving module configured to receive a program installation instruction or a program upgrade instruction or both from the server;
a program installation module configured to install an application program in the device according to the program installation instruction; and
a program upgrade module configured to upgrade the application program in the device according to the program upgrade instruction.

4. The device according to claim 1, further comprising at least one connector configured to be connected with the at least one peripheral component.

5. The device according to claim 1, further comprising:
a network component configured to be integrated with the core component and configured to transmit information from the device to the server; and
at least one peripheral component configured to be connected with the core component and configured to deliver at least one service.

6. A server, comprising a processor and a non-transitory storage medium, the non-transitory storage medium is configured to store modules comprising:
a service collecting module configured to receive information with respect to at least one service delivered by at least one terminal device;
a service management module configured to manage delivery of the at least one service delivered by the least one terminal device according to the information;
a user service module configured to receive a service request from a user terminal;
a service planning module configured to assign one of the at least one terminal device to deliver the at least one service according to the service request and the information;
a service delivery module configured to transmit the service instruction to the assigned terminal device so that the assigned terminal device delivers the service according to the service instruction; and
an information feedback module configured to feedback service information of the assigned terminal device to the user terminal.

7. The server according to claim 6, wherein the non-transitory storage medium is further configured to store:
a position storing module configured to store geographic positions of at least some terminal devices.

8. The server according to claim 7, wherein the non-transitory storage medium is further configured to store:
a request receiving module configured to receive an inquiry request from the user terminal, wherein the inquiry request comprises a geographic position of the user terminal;
a service inquiry module configured to search at least some services available for delivery within a desired geographic scope for the service from the user terminal according to the geographic positions of the at least some terminal devices; and
an inquiry feedback module configured to feedback the found services to the user terminal.

9. The server according to claim 7, wherein the service planning module is further configured to assign one of the at least one terminal device located within the desired geographic scope to deliver the service; and
the information feedback module is further configured to feedback the geographic position and navigation information of the assigned terminal device.

10. The server according to claim 6, wherein the non-transitory storage medium is further configured to store:
a cooperation interface module configured to connect with a third party service system via a third party cooperation interface, and the third party service system is configured to deliver at least one third party service;
a third party management module configured to manage the at least one third party service;
a third party receiving module configured to receive at least another service request from the user terminal for the at least one third party service; and
a third party delivery module configured to cooperate with the third party service system to deliver the at least one third party service to the user terminal.

11. A user terminal, comprising a processor and a non-transitory storage medium, the non-transitory storage medium is configured to store:
a request sending module configured to send a service request of at least one service to a server, wherein the server manages one or more services delivered by one or more terminal devices; and
a feedback receiving module configured to receive service information with respect to the one or more services from the server, wherein the server assigns one of the one or more terminal devices to deliver the at least one service.

12. The user terminal according to claim 11, wherein the non-transitory storage medium is further configured to store:
a position locating module configured to obtain a desired geographic position for delivering the service; and
an inquiry sending module configured to send an inquiry request to the server, wherein the inquiry request comprises the obtained geographic position for delivering the service so that the server searches at least some services available for delivery within a preset scope of the obtained geographic position according to at least some geographic positions of the terminal devices stored in the server, and feeds back the found services to the user terminal, wherein the feedback receiving module is further configured to receive the found services from the server.

13. A service delivery method, comprising:
collecting, by at least one terminal device, information with respect to at least one service provided by the at least one terminal device;
reporting, by the at least one terminal device, the information to a server that receives information from multiple terminal devices;
receiving, by one of the at least one terminal device, a service instruction from the server, wherein the server selects the one of at least one terminal device to deliver the service based on the received information; and
delivering, by the at least one terminal device, the service based on the service instruction.

14. The service delivery method according to claim 13, wherein the information with respect to the at least one service provided by the at least one terminal device comprises a geographic position of the at least one terminal device.

15. The service delivery method according to claim 13, further comprising:
receiving, by the at least one terminal device, an indication from the server that an update to an application program of the at least one terminal device is available;
downloading, by the at least one terminal device, an updated application program from the server; and
upgrading the application program of the at least one terminal device with the updated application program.

16. The service delivery method according to claim 13, further comprising feedbacking service information of the assigned terminal device with respect to the service request to a user terminal, wherein the server receives a service request from the user terminal and sends the service instruction to the one of at least one terminal device based on the received service request, and the user terminal is configured to receive the service request from a user.

17. A service delivery method, comprising:
receiving, by a server comprising a processor and a non-transitory storage medium, information with respect to one or more services delivered by a plurality of terminal devices;
receiving at least one service request from at least one user terminal;
processing the information and the at least one service request;
assigning one of the plurality of the terminal devices to deliver a service based on the service request;
transmitting a service instruction to the assigned terminal device so that the assigned terminal device delivers the service to the user terminal according to the service instruction; and
feedbacking service information of the assigned terminal device with respect to the service request to the user terminal.

18. The method according to claim 17, wherein the information with respect to the one or more services comprises the geographic positions of the plurality of terminal devices which deliver the one or more services.

19. The method according to claim 17, wherein the service request comprises at least a desired geographic scope for the service from the user terminal and the server assigns one of the plurality of the terminal devices based on the desired geographic scope.

20. The method according to claim 19, wherein the service information feedback to the user terminal further comprises the geographic position and navigation information of the assigned terminal device.

21. The method according to claim 17, further comprising:
connecting with at least one third party service system via at least one third party cooperation interface, wherein the at least one third party service system is configured to deliver at least one third party service;
managing the at least one third party service;
receiving at least another service request from the user terminal for the at least one third party service; and
cooperating with the at least one third party service system to deliver the at least one third party service to the user terminal.
